(19) United States
(12) Patent Application Publication
(10) Pub. No.: US 2026/0080591 A1
(43) Pub. Date: Mar. 19, 2026

(54) GENERATING CODE TEMPLATES USING MULTIMODAL ANALYSIS

(71) Applicant: Zeta Global Corp., New York, NY (US)

(72) Inventors: Shubhranshu Barnwal, San Francisco, CA (US); Ivan Povalyaev, Prague (CZ); Danny Portman, Johns Creek, GA (US)

(21) Appl. No.: 19/329,498

(22) Filed: Sep. 15, 2025

Related U.S. Application Data
(60) Provisional application No. 63/694,201, filed on Sep. 13, 2024.

(51) Int. Cl. G06T 11/60; G06F 8/35; G06F 40/186; G06F 40/40; G06T 7/11; G06T 7/70

(52) U.S. Cl. CPC G06T 11/60; G06F 8/35; G06F 40/186; G06F 40/40; G06T 7/11; G06T 7/70; G06T 2200/24; G06T 2207/20081

(57) ABSTRACT

The subject technology includes a code generation system for generating code templates for programming tasks. The code generation system may use image analysis to determine a context and/or requirements of a programming task that are captured in an image associated with the task. The code generation system may train one or more object detection models and/or language models using an image ground truth determined using a code mapping tool. The code generation system may generate code templates by combining multiple code fragments generated by the language models into a cohesive file. The code generation templates may be provided to one or more devices that may uses the templates to perform an action such as, for example, generating a piece of content using the template and/or training a next iteration of a code generation model based on the template.

This patent application claims the benefit of priority, under 35 U.S.C. Section 119(e), to Barnwal et al, U.S. Provisional Patent Application Ser. No. 63/694,201 entitled “SYSTEMS AND METHODS FOR GENERATING CODE TEMPLATES USING MACHINE LEARNING AND IMAGE ANALYSIS,” filed on Sep. 13, 2024 (Attorney Docket No. 4525.203PRV), which is hereby incorporated by reference in its entirety.

### TECHNICAL FIELD

The subject matter disclosed herein generally relates to the technical field of machine learning and, more specifically, techniques for generating computer code using machine learning models and image analysis.

### BACKGROUND

Existing methods and systems for writing or explaining computer code lack integration with natural language processing models to increase efficiency and accuracy. Current methods and systems also require extensive knowledge of various programming languages and syntax to be used properly and effectively. Further, there are no ways of conveying the context of programming tasks to conventional methods and systems. Without a contextual understanding of programming tasks, current methods and systems lack a capability to generate code that is specific to a given task, context, or environment. Additionally, conventional methods and systems lack the ability to continually learn and improve through interaction with users, feedback, and/or self-generated data.

The inventors here have recognized several technical problems with such conventional methods and systems. These technical problems include a time-consuming and repetitive process associated with writing or understanding code, particularly with regard to complex programming tasks, the potential for syntax errors and other bugs within code, the complex and time-consuming task of memory management, the challenges associated with developing programs that work across multiple programming languages and platforms, the advanced skills and knowledge that are required for writing code, particularly highly complex code, difficulties in understanding the unique requirements of different programming tasks, the challenges of writing unique code for different tasks, contexts, and environments.

### SUMMARY

Embodiments of the present disclosure present technological improvements as solutions to one or more of the above-mentioned technical problems recognized by the inventors in conventional systems. For example, the code generation system may include one or more generative machine learning models that increase the speed of code generation and reduce the number of syntax errors and other bugs within the code. The models used for code generation may receive inputs from one or more other generative machine learning models to improve the quality of the generated code, tailor the code to a specific context, and ensure the code is a complete solution to the given programming task. The code generation system may also use one or more computer vision techniques to further refine the inputs into the generative machine learning models in order to more accurately and comprehensively communicate the context of a given programming task to the generative models. The code generation system may be configured to generate code in response to natural language requests to reduce the amount of advanced skill and knowledge required for writing computer code. The code generation system may also be configured to generate code templates based on the generated code. The code templates may be configured to be actionable by devices that are given access to the templates. For example, devices that receive access to the code templates may use the code templates to generate a piece of content (e.g., an email message, website, piece of display media (e.g., a digital advertisement), and the like). The devices may also distribute the piece of content to a plurality of user devices (e.g., send email messages, host a website, provide the piece of display media to a placement on an online property, and the like).

### BRIEF DESCRIPTION OF THE DRAWINGS

Some embodiments are illustrated by way of example and not limitation in the figures of the accompanying drawings.

FIG. 1 is a block diagram illustrating a high-level network architecture, according to various embodiments described herein.

FIG. 2 is a block diagram showing architectural aspects of a learning module, according to various embodiments described herein.

FIG. 3 is a block diagram illustrating a representative software architecture, which may be used in conjunction with various hardware architectures herein described.

FIG. 4 is a block diagram illustrating components of a machine, according to some example embodiments, able to read instructions from a machine-readable medium (e.g., a machine-readable storage medium) and perform any one or more of the methodologies discussed herein.

FIG. 5 depicts aspects of an implementation of one or more components of an application server, according to various embodiments described herein.

FIG. 6 depicts aspects of a learning module, according to various embodiments described herein.

FIG. 7 illustrates aspects of an image processed by one or more vision models, according to various embodiments described herein.

FIG. 8 illustrates aspects of a process for generating a code template using a code generation system, according to various embodiments described herein.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

The embodiments discussed herein involve or relate to artificial intelligence (AI). AI may involve perceiving, synthesizing, inferring, predicting and/or generating information using computerized tools and techniques (e.g., machine learning). For example, AI systems may use a combination of hardware and software as a foundation for rapidly performing complex operations to perceive, synthesize, infer, predict, and/or generate information. AI systems may use one or more models, which may have a particular configuration (e.g., model parameters and relationships between those parameters, as discussed below). While a model may have an initial configuration, this configuration can change over time as the model learns from input data (e.g., training data), which allows the model to improve its abilities. For example, a training sample may be input to a model, which may produce an output based on the sample and the configuration of the model itself. Then, based on additional information (e.g., an additional training sample, validation data, reference data, feedback data), the model may deduce and automatically electronically implement a change to its configuration that will lead to an improved output.

Powerful combinations of model parameters and sufficiently large datasets, together with high-processing-capability hardware, can produce sophisticated models. These models enable AI systems to interpret incredible amounts of information according to the model being used, which would otherwise be impractical, if not impossible, for the human mind to accomplish. The results, including the results of the embodiments discussed herein, are astounding across a variety of applications. For example, an AI system can be configured to autonomously analyze images, navigate vehicles, automatically recognize objects, instantly generate natural language, understand human speech, and generate artistic images.

The technology described herein provides a code generation system that integrates language models with computer vision models to generate computer code that may be used to render specific design images. The computer code generated by the code generation system may be structured as dynamic code templates which may be modified to generate personalized designs for digital content including email messages, websites, display advertisements, and the like. For example, the code templates may be personalized by adding different assets (e.g., images, text content, and the like) to one or more content placeholders and/or connecting different endpoints (e.g., web addresses, email addresses, social media accounts) to one or more design elements (e.g., links, buttons, selectable objects, and the like).

The code generation system may use computer vision models to generate a visual representation the context and requirements of a programming task. The visual representation of the context and requirements may be provided to one or more language models that may translate the visual representation into natural language text. A second language model may use the text to generate computer code fragments that are specific to the context and meet the requirements of the visual representation. The code fragments may be combined to generate code templates that may be actionable by one or more devices. For example, the code templates may be used to generate pieces of content that may be published online. The code templates may also be used to train one or more improved iterations of the code generation system.

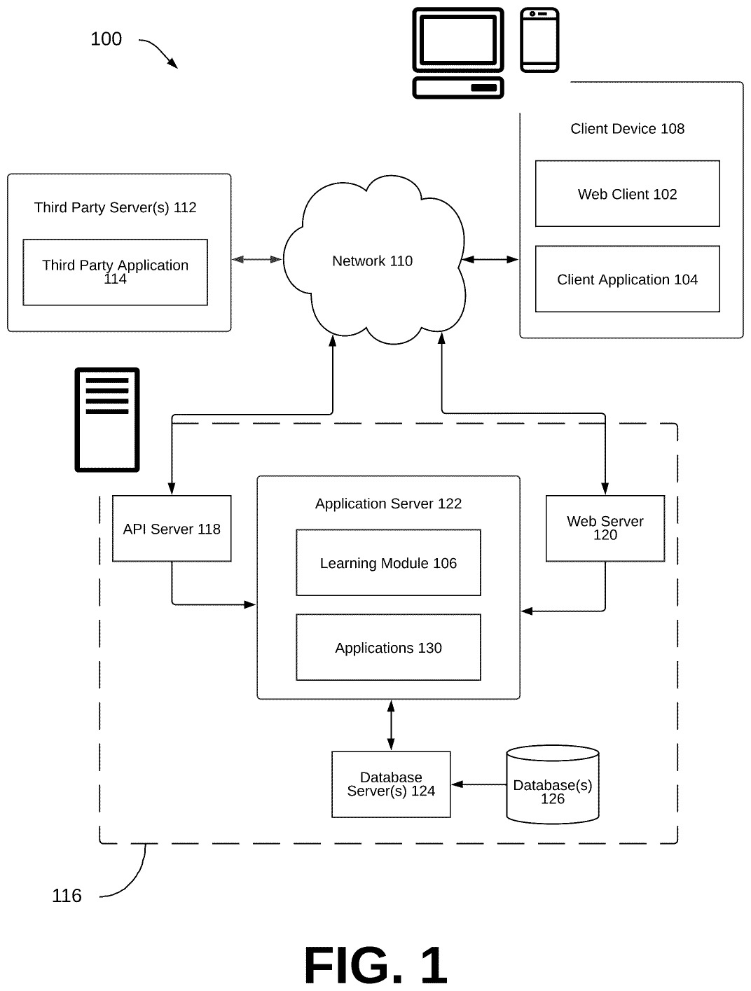

The code generation system may be implemented within a learning module included in the SaaS network architecture described in FIG. 1 below to make the code templates actionable by one or more devices. The SaaS network architecture also enables applications using the code generation system to run on multiple client devices. With reference to FIG. 1, an example embodiment of a high-level SaaS network architecture 100 is shown. A networked system 116 provides server-side functionality via a network 110 (e.g., the Internet or WAN) to a client device 108 (e.g., an internet enabled device). A web client 102 and a programmatic client, in the example form of a client application 104, are hosted and execute on the client device 108.

The networked system 116 includes an application server 122, which in turn hosts one or more applications 130 (e.g., server side applications configured to provide functionality and/or content to end-user clients) that provide a number of functions and services to the client application 104 that accesses the networked system 116. The client application 104 may provide a number of graphical user interfaces (GUIs) described herein that may be displayed on one or more client devices 108 and may receive inputs thereto to configure an instance of the client application 104 and monitor operations performed by the application server 122. For example, the client application 104 may provide conversational user interfaces (UIs) for interacting with language models. To interact with language models, users may enter request in the form of natural language prompts into the conversational UIs and content items including image data and natural language text generated by the language models in response to requests may be displayed in the conversational UIs. The GUIs provided by the client application 104 may present outputs to a user of the client device 108 and receive inputs thereto in accordance with the methods described herein.

The client device 108 enables a user to access and interact with the networked system 116 and, ultimately, the learning module 106 or other applications 130 hosted by the application server 122. For instance, the user provides input (e.g., touch screen input or alphanumeric input) to the client device 108, and the input is communicated to the networked system 116 via the network 110. In this instance, the networked system 116, in response to receiving the input from the user, communicates information back to the client device 108 via the network 110 to be presented to the user.

An API server 118 and a web server 120 are coupled, and provide programmatic and web interfaces respectively, to the application server 122. The application server 122 hosts the learning module 106, which includes components or applications described further below. The application server 122 may also host one or more applications 130 that are linked to the learning module 106. For example, the application server 122 may host a publishing application that distributes one or more pieces of content including image data or other media generated by a generative system (e.g., a language model configured for content generation) included in the learning module 106. The application server 122 is, in turn, shown to be coupled to a database server 124 that facilitates access to information storage repositories (e.g., a database 126). In an example embodiment, the database 126 includes storage devices that store information accessed and generated by the learning module 106 and/or applications 130.

Additionally, a third-party application 114, executing on one or more third-party servers 112, is shown as having programmatic access to the networked system 116 via the programmatic interface provided by the API server 118. For example, the third-party application 114, using information retrieved from the networked system 116, may support one or more features or functions of a generative AI system, website, streaming platform, and the like hosted by a third party.

Turning now specifically to the applications hosted by the client device 108, the web client 102 may access the various systems (e.g., the learning module 106) via the web interface supported by the web server 120. Similarly, the client application 104 (e.g., an agent evaluation “app”) accesses the various services and functions provided by the learning module 106 via the programmatic interface provided by the API server 118. The client application 104 may be, for example, an “app” executing on the client device 108, such as an iOS or Android OS application, and/or a desktop application, web application, or other software application to enable a user to access and input data on the networked system 116 in an offline manner and to perform batch-mode communications between the client application 104 and the networked system 116.

FIG. 1 illustrates one embodiment of the network architecture 100 and other embodiments may include one or more other components and/or configurations. For example, one or more of the learning module 106 and/or applications may be hosted by its own server. Further, while the SaaS network architecture 100 shown in FIG. 1 employs a client-server architecture, the present inventive subject matter is of course not limited to such an architecture, and could equally well find application in a distributed, or peer-to-peer, architecture system, for example. The learning module 106 could also be implemented as a standalone software program, which does not necessarily have networking capabilities.

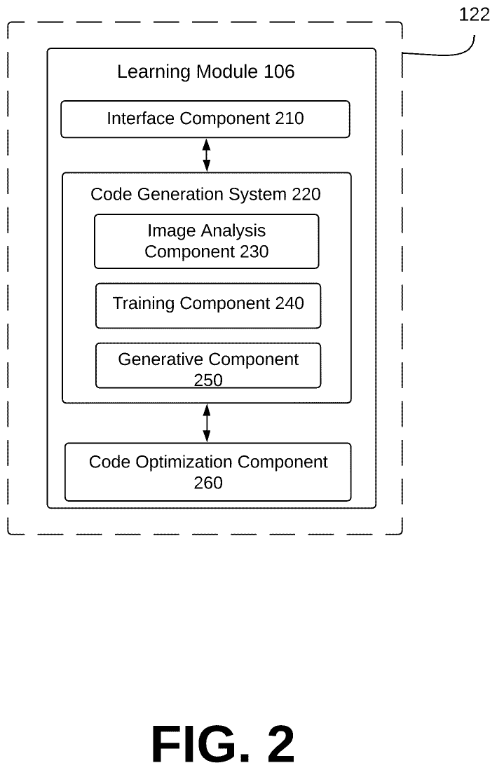

FIG. 2 is a block diagram showing architectural details of a learning module 106, according to some example embodiments. Specifically, the learning module 106 is shown to include an interface component 210 by which the learning module 106 communicates (e.g., over a network 110) with other systems within the SaaS network architecture of FIG. 1.

The interface component 210 may couple the code generation system 220 to one or more applications, databases, and/or other resources to enable images, code, and other training data to be input into the code generation system 220. The code generation system 220 may also use the interface component to distribute code templates generated by the code generation system 220 to one or more devices and/or applications that may use the templates to perform actions. The interface component 210 may be an application programming interface (API) that links one or more applications to the code generation system 220 to enable the code generation system 220 to retrieve training data by sending API requests to one or more database applications and/or data platforms via the interface component 210.

The code generation system 220 may include language model interface 220 may include an image analysis component 230 that may use one or more computer vision models to perform image segmentation, assert detection, optical character recognition (OCR) and other image analysis on images rendered from one or more code samples. The outputs generated by the image analysis component (e.g., image segments, detected objects, and the like) may be input into one generative components 250 that may generate computer code that is specific to the images analyzed by the image analysis component 230. The generative components 250 may include one or more language models configured to generate descriptions of image segments based on the image segments and detected assets generated by the image analysis component 240. The generative components 250 may also include one or more language models configured to generate computer code fragments based on the image segments and the descriptions of the image segments. A training component 240 may train one or more of the computer vision models and/or language models using training samples generated from code samples and images rendered using the code samples. The training component 240 may also include a code mapping tool that may be used to generate one or more image ground truths that may be used during training.

Code fragments generated by the generative components may be combined by a code optimization component 260 to generate code templates. The code templates may combine multiple code fragments to generate a cohesive file that is actionable by one or more devices. For example, the code templates may be used to generate one or more pieces of media that may be displayed and/or published online. The code templates may also be used to train future iterations of the code generation system 220 to improve the performance of the code generation system 220 over time. The code optimization component 260 may incorporate one or more pieces of optimization data into the code templates to personalize the templates for a specific context (e.g., audience, brand, product, design theme or style, and the like) of a programming task.

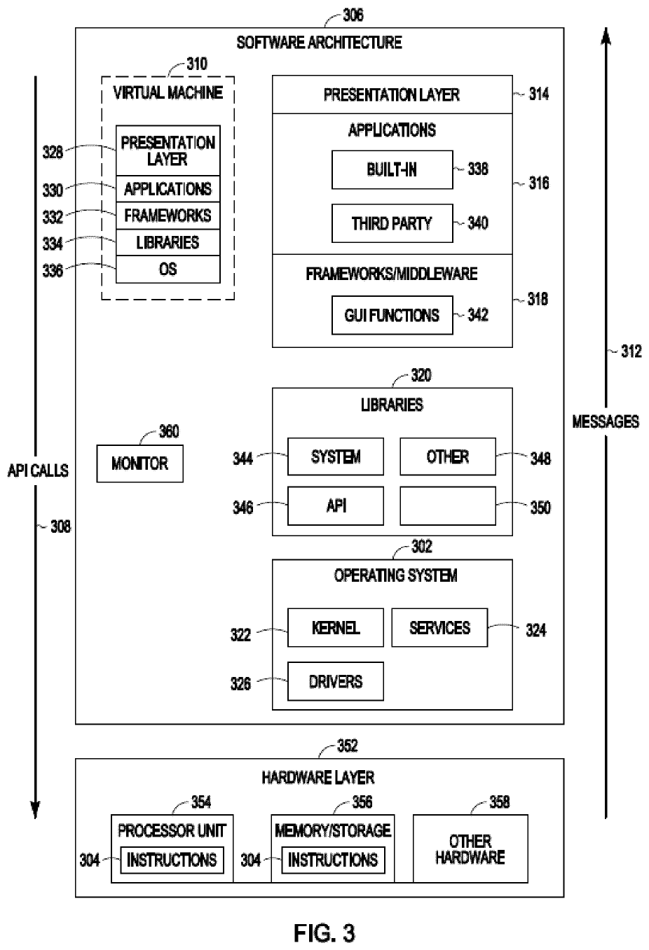

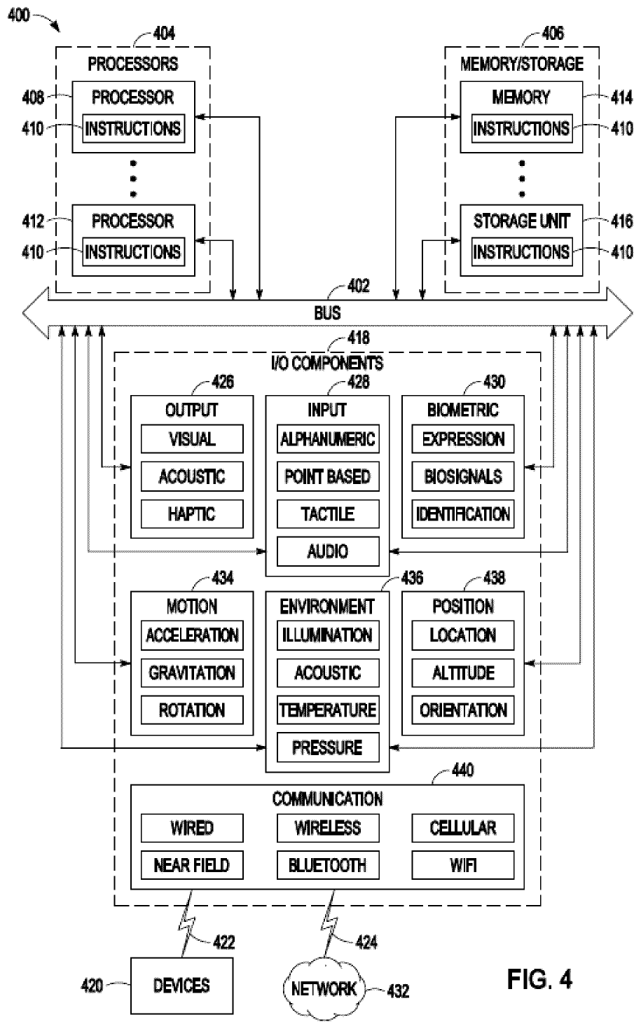

FIG. 3 is a block diagram illustrating an example software architecture 306, which may be used in conjunction with various hardware architectures herein described. FIG. 3 is a non-limiting example of a software architecture 306, and it will be appreciated that many other architectures may be implemented to facilitate the functionality described herein. The software architecture 306 may execute on hardware such as a machine 400 of FIG. 4 that includes, among other things, processors 404, memory/storage 406, and input/output (I/O) components 418. A representative hardware layer 352 is illustrated and can represent, for example, the machine 400 of FIG. 4. The representative hardware layer 352 includes a processor 354 having associated executable instructions 304. The executable instructions 304 represent the executable instructions of the software architecture 306, including implementation of the methods, components, and so forth described herein. The hardware layer 352 also includes memory and/or storage modules as memory/storage 356, which also have the executable instructions 304. The hardware layer 352 may also comprise other hardware 358.

In the example architecture of FIG. 3, the software architecture 306 may be conceptualized as a stack of layers where each layer provides particular functionality. For example, the software architecture 306 may include layers such as an operating system 302, libraries 320, frameworks/middleware 318, applications 316, and a presentation layer 314. Operationally, the applications 316 and/or other components within the layers may invoke API calls 308 through the software stack and receive a response as messages 312 in response to the API calls 308. The layers illustrated are representative in nature, and not all software architectures have all layers. For example, some mobile or special-purpose operating systems may not provide a frameworks/middleware 318, while others may provide such a layer. Other software architectures may include additional or different layers.

The operating system 302 may manage hardware resources and provide common services. The operating system 302 may include, for example, a kernel 322, services 324, and drivers 326. The kernel 322 may act as an abstraction layer between the hardware and the other software layers. For example, the kernel 322 may be responsible for memory management, processor management (e.g., scheduling), component management, networking, security settings, and so on. The services 324 may provide other common services for the other software layers. The drivers 326 are responsible for controlling or interfacing with the underlying hardware. For instance, the drivers 326 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 320 provide a common infrastructure that is used by the applications 316 and/or other components and/or layers. The libraries 320 provide functionality that allows other software components to perform tasks in an easier fashion than by interfacing directly with the underlying operating system 302 functionality (e.g., kernel 322, services 324, and/or drivers 326). The libraries 320 may include system libraries 344 (e.g., C standard library) that may provide functions such as memory allocation functions, string manipulation functions, mathematical functions, and the like. In addition, the libraries 320 may include API libraries 346 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 320 may also include a wide variety of other libraries 348 to provide many other APIs to the applications 316 and other software components/modules.

The frameworks/middleware 318 provide a higher-level common infrastructure that may be used by the applications 316 and/or other software components/modules. For example, the frameworks/middleware 318 may provide various graphic user interface (GUI) functions 342, high-level resource management, high-level location services, and so forth. The frameworks/middleware 318 may provide a broad spectrum of other APIs that may be utilized by the applications 316 and/or other software components/modules, some of which may be specific to a particular operating system or platform.

The applications 316 include built-in applications 338 and/or third-party applications 340. Examples of representative built-in applications 338 may include, but are not limited to, a contacts application, a browser application, a book reader application, a location application, a media application, a messaging application, a publishing application, a content application, a campaign configuration application, performance monitoring application, a scoring application, and/or a game application. The third-party applications 340 may include any application developed using the ANDROID™ or IOS™ software development kit (SDK) by an entity other than the vendor of the particular platform and may be mobile software running on a mobile operating system such as IOS™, ANDROID™, WINDOWS® Phone, or other mobile operating systems. The third-party applications 340 may invoke the API calls 308 provided by the mobile operating system (such as the operating system 302) to facilitate functionality described herein.

The applications 316 may use built-in operating system functions (e.g., kernel 322, services 324, and/or drivers 326), libraries 320, and frameworks/middleware 318 to create user interfaces to interact with users of the system. Alternatively, or additionally, in some systems, interactions with a user may occur through a presentation layer, such as the presentation layer 314. In these systems, the application/component “logic” can be separated from the aspects of the application/component that interact with a user.

Some software architectures use virtual machines. In the example of FIG. 3, this is illustrated by a virtual machine 310. The virtual machine 310 creates a software environment where applications/components can execute as if they were executing on a hardware machine (such as the machine 400 of FIG. 4, for example). The virtual machine 310 is hosted by a host operating system (e.g., the operating system 302 in FIG. 3) and typically, although not always, has a virtual machine monitor 360, which manages the operation of the virtual machine 310 as well as the interface with the host operating system (e.g., the operating system 302). A software architecture executes within the virtual machine 310 such as an operating system (OS) 336, libraries 334, frameworks 332, applications 330, and/or a presentation layer 328. These layers of software architecture executing within the virtual machine 310 can be the same as corresponding layers previously described or may be different.

FIG. 4 is a block diagram illustrating components of a machine 400, according to some example embodiments, able to read instructions from a non-transitory machine-readable medium (e.g., a non-transitory machine-readable storage medium) and perform any one or more of the methodologies discussed herein. Specifically, FIG. 4 shows a diagrammatic representation of the machine 400 in the example form of a computer system, within which instructions 410 (e.g., software, a program, an application, an applet, an app, or other executable code) for causing the machine 400 to perform any one or more of the methodologies discussed herein may be executed. As such, the instructions 410 may be used to implement modules or components described herein. The instructions 410 transform the general, non-programmed machine 400 into a particular machine 400 programmed to carry out the described and illustrated functions in the manner described. In alternative embodiments, the machine 400 operates as a standalone device or may be coupled (e.g., networked) to other machines. In a networked deployment, the machine 400 may operate in the capacity of a server machine or a client machine in a server-client network environment, or as a peer machine in a peer-to-peer (or distributed) network environment. The machine 400 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 410, sequentially or otherwise, that specify actions to be taken by the machine 400. Further, while only a single machine 400 is illustrated, the term “machine” shall also be taken to include a collection of machines that individually or jointly execute the instructions 410 to perform any one or more of the methodologies discussed herein.

The machine 400 may include processors 404 (including processors 408 and 412), memory/storage 406, and I/O components 418, which may be configured to communicate with each other such as via a bus 402. The memory/storage 406 may include a memory 414, such as a main memory, or other memory storage, and a storage unit 416, both accessible to the processors 404 such as via the bus 402. The storage unit 416 and memory 414 store the instructions 410 embodying any one or more of the methodologies or functions described herein. The instructions 410 may also reside, completely or partially, within the memory 414, within the storage unit 416, within at least one of the processors 404 (e.g., within the processor's cache memory), or any suitable combination thereof, during execution thereof by the machine 400. Accordingly, the memory 414, the storage unit 416, and the memory of the processors 404 are examples of machine-readable media.

The I/O components 418 may include a wide variety of components to receive input, provide output, produce output, transmit information, exchange information, capture measurements, and so on. The specific I/O components 418 that are included in a particular machine will depend on the type of machine. For example, portable machines such as mobile phones will likely include a touch input device or other such input mechanisms, while a headless server machine will likely not include such a touch input device. It will be appreciated that the I/O components 418 may include many other components that are not shown in FIG. 4. The I/O components 418 are grouped according to functionality merely for simplifying the following discussion, and the grouping is in no way limiting. In various example embodiments, the I/O components 418 may include output components 426 and input components 428. The output components 426 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 428 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 418 may include biometric components 430, motion components 434, environment components 436, or position components 438, among a wide array of other components. For example, the biometric components 430 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 434 may include acceleration sensor components (e.g., accelerometer), gravitation sensor components, rotation sensor components (e.g., gyroscope), and so forth. The environment components 436 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas sensors to detect concentrations of hazardous gases for safety or to measure pollutants in the atmosphere), or other components that may provide indications, measurements, or signals corresponding to a surrounding physical environment. The position components 438 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 418 may include communication components 440 operable to couple the machine 400 to a network 432 or devices 420 via a coupling 424 and a coupling 422, respectively. For example, the communication components 440 may include a network interface component or other suitable device to interface with the network 432. In further examples, the communication components 440 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 420 may be another machine or any of a wide variety of peripheral devices (e.g., a peripheral device coupled via a USB).

Moreover, the communication components 440 may detect identifiers or include components operable to detect identifiers. For example, the communication components 440 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 440, such as location via Internet Protocol (IP) geo-location, location via Wi-Fi® signal triangulation, location via detecting an NFC beacon signal that may indicate a particular location, and so forth.

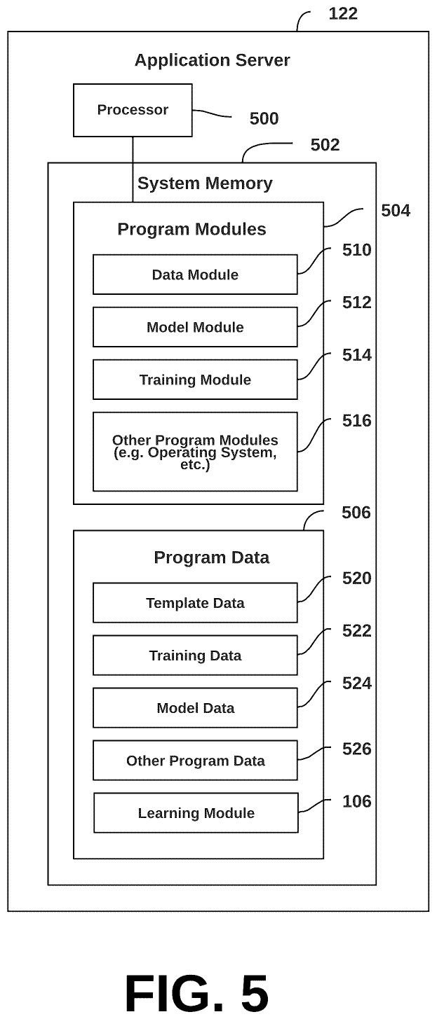

FIG. 5 illustrates an application server 122 hosting a learning module. The application server 122 may include at least one processor 500 coupled to a system memory 502 that may include computer program modules 504 and program data 506. In various embodiments, program modules 504 may include a data module 510, a model module 512, a training module 514, and other program modules 516 such as an operating system, device drivers, and so forth. Each module 510 through 516 may include a respective set of computer-program instructions executable by one or more processors 500.

This is one example of a set of program modules, and other numbers and arrangements of program modules are contemplated as a function of the particular design and/or architecture of the learning module. Additionally, although shown as a single application server, the operations associated with respective computer-program instructions in the program modules 504 could be distributed across multiple computing devices. Program data 506 may include data, program instructions, and other resources consumed by the program modules 504 to provide the functionality described herein. In various embodiments, program data 506 may include template data 520, training data 522, model data 524, and other program data 526 such as data input(s), third-party data, and/or others. Program data 506 may also include instructions, data, and other resources used to implement the learning module described further below.

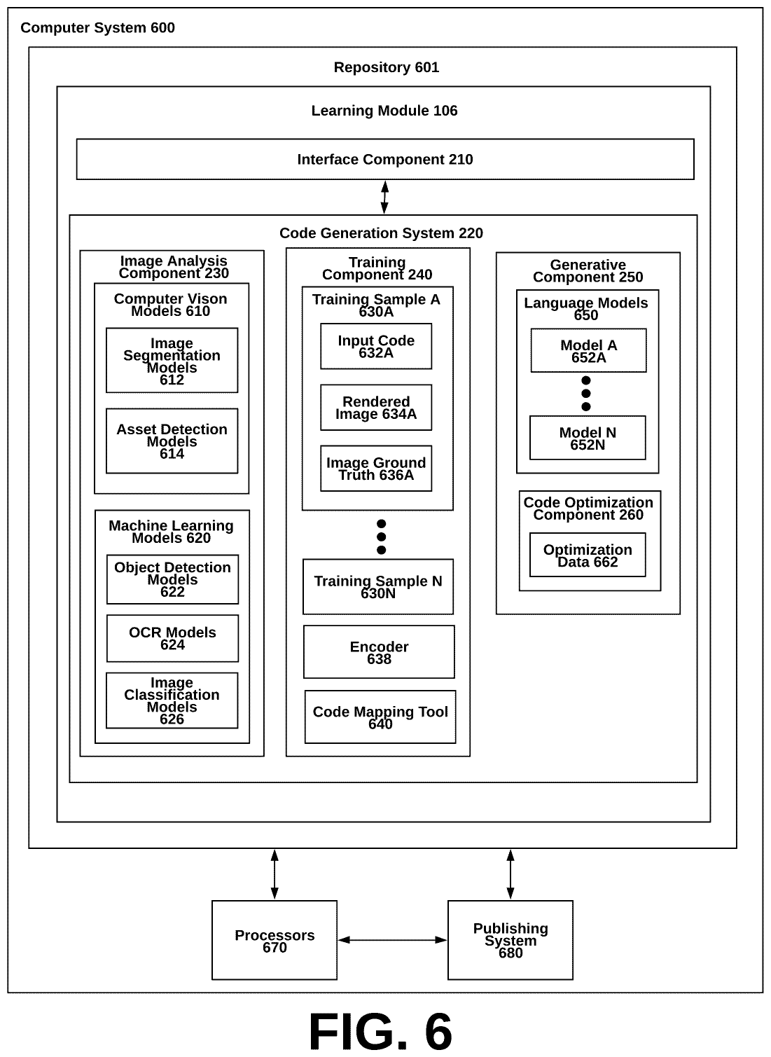

FIG. 6 is a block diagram illustrating more details of the learning module 106 in accordance with one or more embodiments of the disclosure. The learning module 106 may be implemented using a computer system 600 that may include a repository 601, publishing system 680, and one or more computer processors 670. The computer system 600 may take the form of the application server 122 described above in FIG. 1 or any other computer including a processor and memory. The computer processor(s) 670 may take the form of the processor 500 described in FIG. 5.

The learning module 106 may include an application interface component 210 connected to a code generation system 220. The application interface component 210 may provide user requests including programming tasks for the code generation system 220 to perform. The user requests may be request messages formatted as language model prompts that are input into one or more language models 632 of the code generation system. The user requests may also include one or more pieces of image data (e.g., an image file) that provide context and/or requirements for the programming tasks. Code templates generated by the code generation system 220 may be provided to the application interface component 210 which may transmit the templates to other devices. For example, the interface component 210, may provide the code templates to one or more devices (e.g., an application server) implementing the publishing system 680 for use in generating pieces of digital content (e.g., emails, websites, display advertisements, and the like) that will be distributed online by the publishing system 680.

The code generation system 220 may include an image analysis component 230 that may process image data included in the user requests. The image analysis component may include computer vision models 610 and machine learning models 620 configured to perform image processing tasks. The computer vision models 610 may include one or more image segmentation models 612 that may generate image segments that split the image data received from the interface component 210 into multiple distinct sections. For example, the image segmentation models 612 may determine image segments that split an image of a design for an email message template into a first image segment that includes the header portion of the template, a second image segment that includes the footer portion of the template, and one or more additional image segments (e.g., a third image segment, forth image segment, and so on) that include the main body portion of the template.

The image segmentation models 612 may be computer vision models trained on image datasets (e.g., training images of designs of email message templates). The trained image segmentation models 612 may distinguish which pixels in the image data that belong to each section of the design based on, for example, the pixel locations of different sections in the training images, the objects in the different sections in the training images, and/or the contrasts between the pixels in each section and the pixels that form the boarders between the sections. The trained image segmentation models 612 may also limit the size of the image segments in order to avoid including too many objects in a segment. For example, the image segmentation models 612 may limit the number of objects in an image segment to a pre-determined number (e.g., four). The trained image segmentation models 612 may create additional segments (e.g., create two image segments for a main body section that includes five objects) to prevent image segments from including too many objects.

After image segmentation, the image analysis component 230 may perform asset detection on each segment to identity the objects and text included in each segment. The image analysis component may use a combination of computer vision models 610 and machine learning models 620 to perform asset detection. For example, then computer vision models 610 may include one or more asset detection models 614 such as, for example, an Otsu thresholding model that may be used to determine the objects included in the image segments. The machine learning models 620 may include one or more object detection models 622 such as, for example, a YOLO (You Only Look Once) family model and/or RetinaNet models that may be used to identify objects included in the image segments. The machine learning models 620 may also include one or more OCR models 624 may be used to determine the text included in the image segments.

The Otsu thresholding model may detect objects by determining an optimal threshold value for separating pixels into two clusters (e.g., foreground pixels and background pixels). The Otsu thresholding model may use the threshold value to separate the pixels in each image segment and identify the pixels in the foreground cluster as including objects. The YOLO family model and RetinaNet model are both deep learning models that include multiple convolution layers that may be used for feature detection and multiple pooling layers that may be used identify objects based on the features. The YOLO family models may divide an input image into a grid of cells, calculate the image features in each cell, and predict bounding boxes and class probabilities for each cell based on the features. A post processing step may be used to consolidate a large number of candidate bounding boxes into a final prediction that is used for object detection. The RetinaNet models may classify proposal regions in an input image, calculate the image features in each of the proposal regions, and predict the bounding boxes and class probabilities for each region.

Multiple computer vision based asset detection models 614 and machine learning based object detection models 622 may be combined to improve the accuracy of object detection. For example, an Otsu thresholding model may be used to determine an initial set of objects in each image segment. The image segment may then be input into a YOLO family and/or RetinaNet model to determine a second set of objects. The set of objects determined by each model may be compared and any additional objects appearing in the second set of objects may be added to the objects detected for the image segment. Combining multiple models for asset detection may improve the accuracy of the detection process because machine learning based models and computer vision models each have different strengths and weaknesses and the strengths of one model may make up for the differences of another model. For example, Otsu thresholding models may not be able to detect objects that have a similar color to the background of the image (e.g., a white shirt on a white background). The machine learning models have a greater capacity to detect objects that have a lower contrast relative to the background, therefore, may detect objects that were missed by the Otsu thresholding models.

The machine learning models may also include one or more OCR models 624 that are used to convert the text content detected in the image segments to machine readable text data. The OCR models 624 may include, for example, Tesseract OCR, Keras OCR, and Rekognition. To improve the accuracy and completeness of the text conversion process, multiple OCR models 624 may be used in parallel and there results may be combined to provide extensive coverage (i.e., high recall) of the detected text. The text data generated by the OCR models 624 and the detected objects identified by the asset detection models 614 and the object detection models 622 may be input into an image classification model 626 that may classify the image segments based on the context and content of each section. For example, the image classification model 626 may classify an image segment as a header portion, footer portion, main body portion, and the like of an email template design based on the text data and objects included in the image segment.

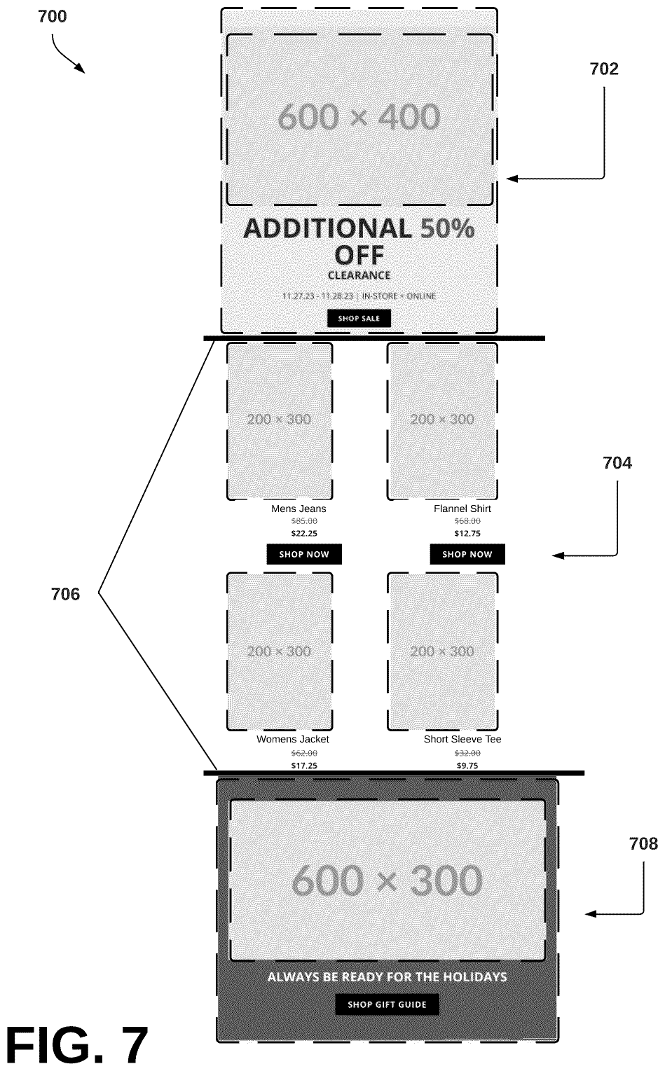

FIG. 7 illustrates an example output of the image segmentation and asset detection performed by the image analysis component for an image of a design template 700. The image segmentation model generated two boundary lines 706 (shown in FIG. 7 as black horizontal lines across the image) that split the image into three segments including a header segment 702, a main body segment 704, and a footer segment 708. The asset detection models and object detection models detected multiple assets in each of the image segments. The boundary lines generated by the models are illustrated as dashed lines around each of the detected assets. For the design template 700, two objects were detected in the header and footer segments 702,708 and four objects were detected in the image body segment 704.

Returning now to FIG. 6, the code generation system 220 may include a training component 240 that trains one or more of the machine learning models 620 of the image analysis component 230 and/or language models 650 of the generative component 250. The training component 240 may generate training data sets that are used to train the models. The training datasets may be generated by combining multiple training samples 630A, . . . , 630N. The training component 240 may generate vision training datasets for training the machine learning models 622 of the image analysis component 620 and language model training datasets for training the language models (LMs) 650 of the generative component 250. The vision training datasets may include composite vectors generated from multi-model data (e.g., images, computer code, ground truth coordinates, and the like) included in the train samples 630A, . . . , 630N for image segments. The language model training datasets may include training prompts including few shot examples of high performing and low performing natural language descriptions and/or code fragments.

The training component 240 may train an object detection model 622 using one or more vision training datasets. Each training sample 630A in the vision training dataset may include a piece of input code 632A, a rendered image 634A rendered using the piece of input code 632A, and an image ground truth 636A. For example, the training samples 630A, . . . , 630N for training an YOLO family model and/or RetinaNet model may include a file including a piece of computer code that may be used to render an image (e.g., HTML/CSS code for an email template) as the input code 632A, image data of an image of the email template design rendered from the code as the rendered image 634A, and a file including pixel coordinates in the image for each element included the design as the image ground truth 636A.

The training component may include an encoder 238 that generates a composite vector representative at least a portion of the input code 632A and/or rendered image 634A in each training sample 630A, . . . , 630N. The encoder 238 may contain a code sub-encoder, an image sub-encoder, and a fusion block that combines the outputs from the sub-encoders into a joint representation composite vector. The code sub-encoder may tokenize the input code 632A (e.g., using Byte-Pair Encoding (BPE) tokenization and/or an abstract syntax tree graph embedding tokenization) and aggregate the tokens with a transformer. The image sub-encoder may extract visual features from the rendered image using a convolutional neural network or vision-transformer. A fusion block (e.g., a cross-attention layer with learned gates) may combine the tokenized code and image embeddings into a composite vector that is stored with the training sample. The learned gates may enable the encoder 238 to dynamically control how much information from each modality (e.g. code vs. image) is incorporated into the composite vector.

The training component 230 may include a code mapping tool 640 that is used to generate the image ground truth 636A. The code mapping tool 640 may parse the input code 632A to detect one or more visual elements included in the code. The code mapping tool 640 may identify unique visual elements based on one or more tags included in the input code 632A. For example, when parsing HTML/CSS codes the code mapping tool 640 may identify unique visual elements by locating a division tag (e.g., “<div>”) and grouping all of the code before the division tag into the same visual element. The code mapping tool 640 may locate each visual element identified in the code in the rendered image based on the position of the element within the code file. The code mapping tool 640 may determine a set of pixel coordinates that may be used to identify the location of a visual element in the rendered image. To determine the pixel coordinates the code mapping tool 640 may identify an origin pixel (e.g., a pixel in the top left corner of the image, a pixel in the center of the image, and the like) having coordinates 0,0. The code mapping tool 640 may then determine the coordinates for the other pixels containing the visual element based on the distance these pixels are from the origin pixel. For example, the code mapping tool 640 made determine the pixel coordinates for a pixel including a visual element that is 20 pixels to the right of the origin pixel and 140 pixels lower than the origin pixel are 20, 140. The code mapping tool 640 may determine the pixel coordinates for each pixel that includes a visual element. The code mapping tool 640 may generate an image ground truth 636A for a training sample 630A used to train an object detection model by may combining the pixel coordinates determined for the pixels that contain each visual element into a set of object coordinates. The code mapping tool 640 may combine the object coordinates for each visual element into a file that may be used as the image ground truth during training.

To train the object detection models 622, the training samples 630A, . . . , 630N in the vision training dataset may be divided into a training portion and a test portion. The rendered images 634A in the training portion of the training samples 630A, . . . , 630 may be input into a YOLO family model and/or RetinaNet model. The convolution layers of the model may identify image features in each rendered image and the output layers of the model may determine the pixel coordinates for each object detected in the rendered image based on the image features. In various embodiments, the output layers of object detection model 622 may include an alignment head that consumes the composite vector output by the encoder 238 and a set of code elements (e.g., object declarations, class tags, and the like identified by the convolution elements and/or determined by the code mapping tool 640) and generates, for each element, a pixel-space mapping such as a bounding box (x,y,w,h)(x,y,w,h)(x,y,w,h), a segmentation mask, a set of coordinates, and the like. The alignment head may implement an attention mechanism trained based on the code tokens and/or image embeddings to optimize the pixel coordinates of the pixel-space mapping. The pixel coordinates of the predicted pixel-space mapping may by aggregated to generate a predicted image ground truth that specifies where each code-defined object is expected to appear in the rendered image at a defined pixel resolution.

The pixel coordinates for the detected objects generated by the model may be compared to the object coordinates of the image ground truth 636A to determine a detection loss for the model. During training, the predicted ground truth generated by the object detector model 622 may be matched to the labeled image ground truth detected by the code mapping tool 640 for each training sample. The predicted image ground truth may provide auxiliary targets and/or consistency constraints and the detection losses may include classification loss (cross-entropy or focal), box regression loss, mask loss, and/or an alignment loss that penalizes discrepancies between predicted and labeled image ground truths. The total loss may be minimized using an optimizer such as AdamW or SGD with a scheduled learning rate and curriculum or sample weighting can prioritize samples whose predicted and labeled ground truths agree. The parameters of the convolution layers and/or output layers may be modified in the direction of the loss based on calculated gradients to reduce the detection loss. Repeating these steps over the training dataset may improve the accuracy of the pixel coordinates in the predicted pixel-space mapping determined by the object detection model 622 relative to the object coordinates in the image ground truth 636A. Once a minimum and/or threshold level of detection loss is achieved during training, the trained model may be validated using the training samples included in the test portion of the training dataset.

The training component 240 may also train one or more LMs 650 of the generative component 250 using LM training datasets. The generative component 250 may include multiple LMs that are used to generate code templates for code programming tasks having a particular context and/or requirements that are captured in the outputs of the image processing component 230. For example, the LMs of the generative component 250 may generate code templates for a piece of digital content (e.g., email messages, websites, display advertisements, and the like). Each code template may have different visual elements that are included in an particular design for the piece of content shown in the image processed by the image analysis component 230.

One of the models 652A of the LMs 650 may include a segment description generator that creates a detailed description of the layout and content of each image segment. The segment description may include color schemes, interactive button structures, and other design details that are shown in the images processed by the image analysis component 230. The LM used for the segment description generator may be a multimodal large language model (MLLM) that may be configured to generate text based on image and text inputs. To generate the segment descriptions, the image data for an image segment may be input into the segment description generator LM along with the extracted assets, OCR text, and segment classification generated by the image analysis component 230. An LM prompt that explains the inputs and provides instructions to the model to generate a natural language description of the image segment may also be input into the LM. The segment description generator may generate a text description for the input image segment based on the inputs and the prompt.

The training component 240 may generate one or more fine-tuning prompts to improve the performance of the segment description generator LM. The fine-tuning prompts may include a few shot examples of high performing and low performing descriptions. The few shot examples included in the tuning prompts may may each include an sample image segment (e.g., the raw image data and or image embeddings for the image segment) and a labeled natural language description that was generated for each image segment. A portion of the image segments in few shot examples may be paired with natural language descriptions that are high performing and a portion of the image segments may be paired with natural language descriptions that are low performing. The high performing descriptions and low performing descriptions will be labeled as high and low performing respectively and the instructions in the fine tuning prompts may indicate the segment description generator LM is to generate text descriptions that are more like the high performing descriptions and not like the low performing descriptions to ensure the segment description generator is aligning the generated segment descriptions with the high performing examples.

Another model 652N of the LMs 650 may include a code generator model configured to generate a piece of computer code (e.g., a code fragment) that corresponds to an image segment. The code generator model may be a MLLM configured to generate computer code based on image and text inputs. To generate a code fragment, image data of an image segment and a text description of the image data generated by the segment description generator may be input into the code generator model. An LM prompt that explains the inputs and provides instructions to the model to generate a piece of code that may be used to render the input image segment may also be input into the model. The code generator model may generate a code fragment for the input image segment based on the input image data and the prompt.

The training component 240 may train the code generator model using one or more LM training datasets including training samples 630A, . . . , 630N. To train the code generator model, a training portion of the training samples 630A, . . . , 630N may be selected. The rendered image 634A and input code 632A for the training samples 630A, . . . , 630N may be input into the model as a request, completion pair. A training prompt may also be input into the model that includes instructions for the model that define a role for the model (e.g., generate code that may be used to render an image that includes all of the visual elements in an input image data) and indicate the input rendered images are examples of the images that should be rendered using the code generated by the model and the input code are examples of code fragments that should be generated for their corresponding input rendered images.

The trained code generator model may generate code fragments for rendered images included in a testing portion of the training samples 630A, . . . , 630N that were not used during training. For each training sample 630A in the testing portion, the rendered image 634A may be provided to the code generation model along with a text description of the rendered image 634A generated by the image segment description generator model. The LM prompt for generating code fragments may also be input into the code generation model and the model may generate a code fragment in response to the inputs and the prompt. To determine the performance of the code generation model the code fragment may be compared to the input code 632A in the training sample. For example, a score (e.g., a similarity score, for example, cosine similarity) for each code generated fragment may be determined by comparing the generated code fragment to the input code 632A. To determine the cosine similarity, the code of the generated code fragment and the code of the input code 632A may be converted into a numerical vector representation using a text encoder (e.g., an encoder model implementing a text to vector algorithm (e.g., bag-of-words, tf-idf, and the like) and/or the portion of the code generation model used to calculate word embeddings). The cosine similarity between the code fragment vector and the input code vector may be calculated. A performance score for the code generation model may be determined by aggregating the similarity scores determined for the generated code fragment for each training sample in the testing portion. The performance score may be compared to a performance score threshold. If the performance score for the code generation model meets or exceeds the performance score threshold, the code generation model may be deployed to production and made available for inference. If the performance score for the code generation model is below the performance score threshold, the code generation model may be retrained based on at least one of the performance scores, the generated code fragments, the original LM training dataset, and a new LM training dataset until the performance score for the retrained version of the code generation model meets and/or exceeds the performance score threshold.

To improve the performance of the code generation model one or more additional performance scores may be determined. For example, an image performance score may be determined for each generated code fragment by using the code fragments to render an image (e.g., a generated image) and comparing the generated images for each training sample in the testing portion to the rendered image 634A. A similarity score may be calculated to perform the comparison. To determine a similarity score, the generated image and rendered image 634A may be converted into a numerical vector representation using an image encoder configured to calculate image embeddings for the image data of each generated image and rendered image 634A. The image embeddings for each piece of image data may be aggregated to generate a vector for each image. The cosine similarity between the generated image vector and the rendered image vector may be calculated. An image performance score for the code generation model may be determined by aggregating the similarity scores determined for the generated images determined for each code fragment generated for each training sample in the testing portion.

A ground truth performance score may also be determined for each generated code fragment. To determine the ground truth performance score, an image ground truth for each code fragment may be determined by the code mapping tool 640 based on the generated image and the code fragment. The generated ground truth for the generated fragments for each training sample in the testing portion may be compared to the image ground truth 636 by calculating a similarity score for each generated ground truth. To determine the similarity score, the object coordinates in the generated ground truth and the object coordinates in the image ground truth 636A may be converted into a numerical vector representation using a coordinate encoder configured to calculate ground truth embeddings for the coordinates in each generated ground truth file and the coordinates in each image ground truth 636A file. The ground truth embeddings may be aggregated to generate a vector for each ground truth file. The cosine similarity between the generated ground truth vector and the image ground truth vector may be calculated. A ground truth performance score for the code generation model may be determined by aggregating the similarity scores determined for the generated ground truth determined for the code fragments generated for each training sample in the testing portion.

The image performance score and/or ground truth performance score may be combined with the original performance score to generate a composite performance score. For example, two or more of the performance scores may be averaged or combined using a weighted average that makes the composite performance score more dependent on the performance score having the highest weight (e.g., the most important score, the score with the highest degree of confidence, and the like). The composite performance score may be compared to a composite score threshold. If the composite performance score for the code generation model meets or exceeds the composite score threshold, the code generation model may be deployed to production and made available for inference. If the composite performance score for the code generation model is below the composite score threshold, the code generation model may be retrained based on at least one of the performance scores, the generated code fragments, the original LM training dataset, and a new LM training dataset until the composite performance score for the retrained version of the code generation model meets and/or exceeds the composite score threshold.

A code optimization component 660 may combine the code fragments for different image segments into a code template that may be actioned by one or more devices. The code optimization component 660 may generate a generic template and inset the code fragments into the generic template to generate a code template. One or more tags included in the code fragment may enable the code optimization component 660 to distinguish between different code fragments so that the portions of the template that correspond to each image segment may be separated. The code optimization component 660 may also embed optimization data 662 into the code template to personalize the code template for a particular piece of content, brand, audience, and the like. For example, the code optimization component 660 may combine code fragments for image segments corresponding to a header, main body, and footer portion of a design for an email template into a code template written in HTML, CSS, Tailwind, and/or Java Script (JS). The optimization component 660 may embed code optimization data 662 such as, for example, an email address inbox, web address, application, data resource, or other endpoint in one or more of the elements (e.g., buttons, links, images, and the like) that should navigate to the endpoint when a user interacts with the element.

The code templates generated by the code optimization component 660 may be provided to one or more devices. For example, the code templates may be provided to a publishing system 680 that includes a content generation application configured to use the code template to generate a piece of content. The piece of content may then be provided to a publisher application of the publishing system 680 that is configured to publish the piece of content online. The code templates may also be provided to the training component 240 of the code generation system for use in training one or more LMs (e.g., future iterations of the code generation models.

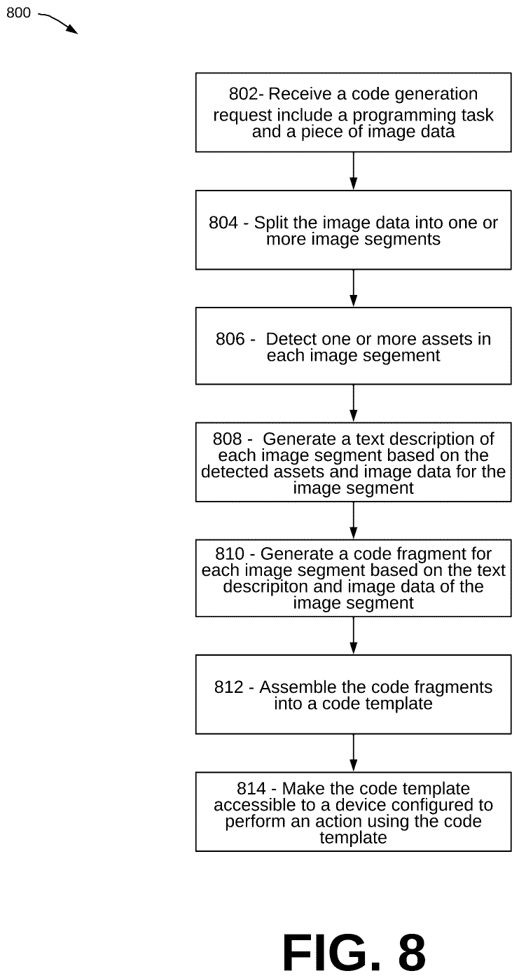

Embodiments of the present invention may also include methods. FIG. 8 illustrates an example method of using the code generation system to generate a code template. At step 802, the code generation system may receive a code generation request that includes a programming task for the code generation system to perform and a piece of image data that provides context and/or requirements for the programming task. For example, the code generation system may include a code generation request including instructions to generate a code template written in HTML, CSS, JS, and/or tailwind that may be used to render a design show in the image data.

At step 804, the image analysis component may split the piece of image data included in the request into one or more image segments. For example, the image segments for an image of a design of an email message template may include a first image segment including image data corresponding to a header portion of the email design, a second image segment including image data corresponding to a main body portion of email design, and a third image segment including image data corresponding to a footer portion of the email design.

At step 806 one or more machine learning models included in the image analysis component may detect one or more assets in each of the one or more image segments. The machine learning models may include an object detection model trained object detection model trained on a set of training samples. Each sample in the set of training samples may include a piece of input code, a rendered image generated using the input code, an image ground truth generated using the input code and the rendered image. The machine learning models may also include one or more asset detection models and/or OCR models that are used to detect images and text content respectively.

At step 808, a text description of each image segment may be generated based on the detected assets and image data for the image segment. To generate the text description, the one or more image segments and the one or more objects detected by the machine learning model may be input into to a first generative machine learning model (e.g., a segment description generator MLLM) configured to generate a text description for the one or more image segments.

At step 810, a code fragment may be generated for each image segment based on the text description generated by the first generative machine learning model and image data of the image segment. To generate the code fragments the one or more image segments and the text descriptions for the one or more image segments generated by the first generative machine learning model may be input into a second generative machine learning model (e.g., a code generation MLLM) configured to generate a code fragment that may be used to render an image of the one or more image segments. The second generative machine learning model may include a LM trained on a set of code samples used to render image segments and a set of example text descriptions for each image segment. The code fragments generated by the second generative machine learning model may be structured to represent the layout colors and design elements included in the image segments.

At step 812, a code optimizer may assemble the conde fragments into a code template. The code optimizer may generate the code template by generating a generic template and adding each of the code fragments to the generic template. The code optimizer may also embed one or more pieces of optimization data into the cod template to personalize the template. At step 814, the code generation system may make the code template accessible to a device configured to transmit a piece of content generated from the code template to a plurality of user devices. The code generation system may also make the code template accessible to a device configured to train a machine learning model using the code template.

In this disclosure, the following definitions may apply in context. A “Client Device” or “Electronic Device” refers to any machine that interfaces to a communications network to obtain resources from one or more server systems or other client devices. A client device may be, but is not limited to, a mobile phone, desktop computer, laptop, portable digital assistant (PDA), smart phone, tablet, ultra-book, netbook, laptop, multi-processor system, microprocessor-based or programmable consumer electronic system, game console, set-top box, or any other communication device that a user may use to access a network.

“Communications Network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and coupling may be a Code Division Multiple Access (CDMA) connection, a Global System for Mobile communications (GSM) connection, or another type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

“Component” (also referred to as a “module”) refers to a device, physical entity, or logic having boundaries defined by function or subroutine calls, branch points, application programming interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components.

A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors.

It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instant in time. For example, where a hardware component includes a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instant of time and to constitute a different hardware component at a different instant of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“Image data” in this context refers to any type of visual media or other data that includes a number of rows and columns or pixels including, for example, images, frames of video, three dimensional holograms, pixel data, virtual reality (VR) content, augmented reality (AR) content, mixed reality (MR) content, extended reality (XR) content, and the like.

“Machine-Readable Medium” in this context refers to a component, device, or other tangible medium able to store instructions and data temporarily or permanently and may include, but not be limited to, random-access memory (RAM), read-only memory (ROM), buffer memory, flash memory, optical media, magnetic media, cache memory, other types of storage (e.g., Erasable Programmable Read-Only Memory (EPROM)), and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“Processor” refers to any circuit or virtual circuit (a physical circuit emulated by logic executing on an actual processor) that manipulates data values according to control signals (e.g., “commands,” “op codes,” “machine code,” etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), or any combination thereof. A processor may further be a multi-core processor having two or more independent processors (sometimes referred to as “cores”) that may execute instructions contemporaneously.

A portion of the disclosure of this patent document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

Although the subject matter has been described with reference to specific example embodiments, it will be evident that various modifications and changes may be made to these embodiments without departing from the broader spirit and scope of the disclosed subject matter. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Description, therefore, is not to be taken in a limiting sense, and the scope of various embodiments is defined only by any appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system comprising:
one or more processors; and
a memory storing instructions that, when executed by at least one processor in the one or more processors, cause the at least one processor to perform operations for generating a text response corresponding to an object displayed in a user interface (UI) page, the operations comprising:
encoding a piece of input code and a rendered image generated using the input code in a composite vector using an encoder, the composite vector representative of at least a portion of the input code and the rendered image in a training sample;
generating a composite vector for multiple training samples to create a set of composite vectors;
determining a labeled ground truth for each rendered image in the multiple training samples, each labeled ground truth including a set of coordinates for one or more objects included in a particular rendered image;
aggregating the set of composite vectors and the labeled ground truth for each training sample to form a training dataset for training an object detection model;
training the object detection model based on a comparison of a predicted ground truth generated for each training sample the to the labeled ground truth;
receiving a piece of input image data;
splitting the piece of input image data into one or more image segments;
identifying, by the trained object detection model, one or more objects included in the one or more image segments; and
providing the one or more image segments and the one or more objects to a generative component configured to generate a code fragment that may be used to render an image of the one or more image segments.

2. The system of claim 1, wherein the generative component includes a first language model configured to generate a text description for the one or more image segments; and
a second language model configured to generate a code fragment for the one or more image segments, each code fragment may be used to render an image of the one or more image segments, each code fragment generated based on the one or more image segments and the text descriptions for the one or more image segments generated by the first language model.

3. The system of claim 2, wherein the operations further comprise assembling the code fragments for each image segment into a code template; and
making the code template accessible to a device configured to transmit a piece of content generated from the code template to a plurality of user devices.

4. The system of claim 1, wherein the image ground truth includes object coordinates for each of the objects detected by the machine learning model.

5. The system of claim 4, wherein the object coordinates include pixel coordinates that indicate a position of each object in the rendered image.

6. The system of claim 2, wherein the second language model is trained on a set of rendered images and a code sample for each image in the set of rendered images that may be used to render the image.

7. The system of claim 1, wherein the code fragment is structured to represent the layout colors and design elements included in the image segments.

8. The system of claim 2, wherein the second language model is trained by determining a performance score based on each code fragment and modifying the second language model based on the performance score.

9. The system of claim 2, wherein the second language model is trained by determining a composite performance score for each code fragment based on a performance score for the code fragment, an image performance score for an image rendered using the code fragment, and a ground truth performance score for a ground truth generated from the code fragment and the image rendered using the code fragment.

10. The system of claim 3, wherein the operations further comprise embedding one or more pieces of optimization data into the code template to generate a personalized code template.

11. The system of claim 3, wherein the operations further comprise making the code template accessible to a device configured to train a next iteration of the second generative machine learning model based on the code template.

12. A method comprising:
encoding a piece of input code and a rendered image generated using the input code in a composite vector using an encoder, the composite vector representative of at least a portion of the input code and the rendered image in a training sample;
generating a composite vector for multiple training samples to create a set of composite vectors;
determining a labeled ground truth for each rendered image in the multiple training samples, each labeled ground truth including a set of coordinates for one or more objects included in a particular rendered image;
aggregating the set of composite vectors and the labeled ground truth for each training sample to form a training dataset for training an object detection model;
training the object detection model based on a comparison of a predicted ground truth generated for each training sample the to the labeled ground truth;
receiving a piece of input image data;
splitting the piece of input image data into one or more image segments;
identifying, by the trained object detection model, one or more objects included in the one or more image segments; and
providing the one or more image segments and the one or more objects to a generative component configured to generate a code fragment that may be used to render an image of the one or more image segments.

13. The method of claim 12, wherein the generative component includes a first language model configured to generate a text description for the one or more image segments; and
a second language model configured to generate a code fragment for the one or more image segments, each code fragment may be used to render an image of the one or more image segments, each code fragment generated based on the one or more image segments and the text descriptions for the one or more image segments generated by the first language model.

14. The method of claim 13, further comprising assembling the code fragments for each image segment into a code template; and
making the code template accessible to a device configured to transmit a piece of content generated from the code template to a plurality of user devices.

15. The method of claim 12, wherein the one or more image segments include image data corresponding to a header portion, footer portion, and a main body portion of an image of a design that is rendered from the image data.

16. The method of claim 12, wherein the image ground truth includes object coordinates for each of the objects detected by the machine learning model.

17. The method of claim 13, further comprising training the second language model on a set of rendered images and a code sample for each image in the set of rendered images that may be used to render the image.

18. The method of claim 12, wherein the code fragment is structured to represent the layout colors and design elements included in the image segments.

19. The method of claim 13, further comprising training the second language model by determining a performance score based on each code fragment; and modifying the second language model based on the performance score.

20. The method of claim 13, further comprising training the second language model by determining a composite performance score for each code fragment based on a performance score for the code fragment, an image performance score for an image rendered using the code fragment, and a ground truth performance score for a ground truth generated from the code fragment and the image rendered using the code fragment.
